(19) United States
(12) Patent Application Publication
(10) Pub. No.: US 2004/0050931 A1
(43) Pub. Date: Mar. 18, 2004

(54) ID card, ID card issuing device, and ID card reading device

(75) Inventors: Tsukasa Ono, Tokyo (JP); Yuki Egawa, Tokyo (JP)

Correspondence Address: BEYER WEAVER & THOMAS LLP, P.O. BOX 778, BERKELEY, CA, 94704-0778, US

(73) Assignee: KOWA CO., LTD.

(21) Appl. No.: 10/316,975

(22) Filed: Dec. 10, 2002

(30) Foreign Application Priority Data
Sep. 17, 2002 (JP) 2002-270561(P)

(51) Int. Cl. G06K 5/00

(52) U.S. Cl. 235/380

(57) ABSTRACT

The technique of the present invention assumes a watermark image including ID information as an image located in a frequency domain and makes the whole watermark image subjected to an inverse transform from the frequency domain to generate a transformed image. The technique subsequently adds the transformed image to a photographic image to obtain an embedded image with the ID information embedded therein as a digital watermark. The technique then records the embedded image in a predetermined card by means of printing, so as to issue an ID card. This arrangement enables easy detection of any illegal alteration of the ID card, for example, falsification of the photographic image.

### BACKGROUND OF THE INVENTION

1. Field of the Invention

The present invention relates to an ID (identification) card, such as an employee ID card, a member's card, a driver's license, a passport, or a credit card, on which ID information for identifying a holder of the ID card and a photographic image like a head shot of the ID card holder are recorded.

2. Description of the Related Art

ID information for identifying a holder of an ID card, which includes ID number, name, and group of the ID card holder, in the form of character data and a head shot of the ID card holder as a photographic image are recorded on surface of the ID card, such as an employee ID card or a driver's license.

The typical procedure of identification asks each ID card holder to present an ID card, and identifies the ID card holder based on the ID information and the photographic image recorded in the ID card.

One example of the prior art ID card is disclosed in PATENT PUBLICATION GAZETTE NO. 3075221.

With recent advancement of the image processing technique, it is rather easy to substitute a head shot of a different person for the genuine photographic image recorded in the ID card and illegally alter the ID card.

In the case of falsification of the photographic image, since the ID information recorded in the form of character data is genuine, it is extremely difficult to detect that the ID card has been altered illegally, as long as the person of the falsified head shot owns the illegally altered ID card.

### SUMMARY OF THE INVENTION

The object of the present invention is thus to solve the drawbacks of the prior art technique and to provide an ID card that ensures easy detection of any illegal alteration of the ID card, for example, falsification of a photographic image.

In order to attain at least part of the above and the other related objects, the present invention is directed to an ID card with an embedded image recorded therein by means of printing. The embedded image has first ID information for identifying a person embedded therein as a digital watermark. The embedded image is obtained by assuming a watermark image including the first ID information as an image located in a certain frequency domain, making the whole watermark image subjected to an inverse transform from the frequency domain to generate a transformed image, and adding the transformed image to a photographic image that represents part or whole of the person.

The embedded image recorded in the ID card of the present invention by means of printing has the ID information embedded therein as the digital watermark. Such an embedded image is obtained by making the whole watermark image, which includes the ID information, subjected to the inverse transform from the frequency domain to generate a transformed image and adding the transformed image to a photographic image.

In the case of an illegal alteration of the ID card 10, for example, falsification of the photographic image, no ID information is embedded in the photographic image recorded in the ID card or false ID information is embedded in the photographic image. The procedure of the invention reads the embedded image from the ID card, extracts the embedded ID information, and determines whether or not there is any illegal alteration of the ID card 10, such as falsification of the photographic image. This arrangement enables easy detection of the illegal alteration of the ID card 10, such as falsification of the photographic image. This arrangement readily catches out impersonation.

In the specification hereof, the process of ‘addition’ includes addition of a negative value or subtraction.

It is preferable that second ID information for identifying the person is further recorded in the ID card of the present invention.

The ID information is recorded in the ID card, other than being embedded in the photographic image as the digital watermark. This application enables the ID information of the ID card holder to be checked without extraction of the ID information from the photographic image.

The present invention is also directed to an ID card issuing device that issues an ID card. The ID card issuing device includes: an inverse transform module that assumes a watermark image including ID information for identifying a person as an image located in a certain frequency domain, and makes the whole watermark image subjected to an inverse transform from the frequency domain, so as to generate a transformed image; an adder that adds the transformed image to a photographic image representing part or whole of the person, so as to obtain an embedded image with the ID information embedded therein as a digital watermark; and a recording module that records the embedded image in a predetermined card by means of printing, so as to issue the ID card.

The ID card issuing device of the present invention readily issues the ID card with the ID information embedded as the digital watermark in the photographic image.

The present invention is further directed to an ID card reading device that reads information recorded in the ID card. The ID card reading device includes: a reading module that reads an embedded image, which is recorded in the ID card and includes a photographic image representing part or whole of a person and ID information for identifying the person embedded in the photographic image as a digital watermark; a transform module that makes the whole embedded image subjected to a transform into a frequency domain, so as to generate a transformed image; and an extraction module that extracts the ID information from the transformed image.

The ID card reading device of the present invention enables the ID information embedded as the digital watermark to be readily extracted from the embedded image recorded in the ID card.

The present invention is also directed to a method of issuing an ID card. The ID card issuing method includes the steps of: (a) providing ID information for specifying a person and a photographic image that represents part or whole of the person; (b) defining the ID information as a graphic and arranging the graphical ID information at a desired position to generate a watermark image; (c) assuming the watermark image as an image located in a frequency domain and making the whole watermark image subjected to an inverse transform from the frequency domain, so as to generate a transformed image; (d) adding the transformed image to the photographic image, so as to obtain an embedded image with the ID information embedded therein as a digital watermark; and (e) recording the embedded image in a predetermined card by means of printing, so as to issue the ID card.

The ID card issuing method of the present invention readily issues the ID card with the ID information embedded as the digital watermark in the photographic image.

In accordance with one preferable application of the ID card issuing method of the present invention, the step (b) arranges the graphical ID information in a specific area of low and intermediate frequency components, which is defined by two arcs about a point corresponding to a direct current component, on the assumption that the watermark image is the image located in the frequency domain.

This application desirably reduces the possibility of the deteriorating picture quality of the embedded image due to the embedded ID information.

In accordance with another preferable application of the ID card issuing method of the present invention, the step (b) has the sub-step of attaching a marker to a preset position in the generated watermark image.

Even when some geometrical change is applied to the embedded image, attachment of the marker ensures easy specification of the geometrical change in the process of extracting the ID information from the embedded image, thereby allowing easy search for the position of the bit information.

In accordance with still another preferable application of the ID card issuing method of the present invention, the step (b) has the sub-step of successively multiplying a value of each pixel included in the watermark image by a value extracted from a series of random digits prepared in advance to carry out adjustment of the watermark image on its brightness axis.

Adjustment on the brightness axis effectively prevents a significant change in level of a specific frequency due to the presence of the ID information, thus reducing the possibility of the deteriorating picture quality of the embedded image.

In accordance with another preferable application of the ID card issuing method of the present invention, the step (b) has the sub-step of adding virtual compensating pixels to make a size of the generated watermark image equal to a preset size.

When a particular transform algorithm is used for the inverse transform of the whole watermark image from the frequency domain in the step (c), the arrangement of adding the virtual compensating pixels to make the size of the watermark image equal to the preset size facilitates computation of the inverse transform.

In the ID card issuing method of the present invention, it is preferable that the step (c) applies inverse discrete cosine transform or inverse discrete Fourier transform for the inverse transform.

The inverse discrete cosine transform and the inverse discrete Fourier transform are typical inverse transforms from the frequency domain.

The present invention is further directed to a method of reading information recorded in an ID card. The ID card reading method includes the steps of: (a) providing the ID card with an embedded image recorded therein, where the embedded image has ID information for identifying a person embedded as a digital watermark in a photographic image representing part or whole of the person; (b) reading the embedded image from the ID card; (c) making the whole embedded image subjected to a transform into a frequency domain, so as to generate a transformed image; and (d) extracting the ID information from the transformed image.

The ID card reading method of the present invention enables the ID information embedded as the digital watermark to be readily extracted from the embedded image recorded in the ID card.

In accordance with one preferable application of the ID card reading method of the present invention, the step (b) has the sub-step of making the embedded image subjected to a filtering process.

The filtering process eliminates non-required frequency components, thus ensuring easy extraction of the ID information.

In accordance with another preferable application of the ID card reading method of the present invention, the step (d) has the sub-step of detecting a marker in the transformed image, specifying a geometrical change applied to the embedded image based on a status of the detected marker, carrying out a correction to compensate for the geometrical change, and searching for a position of the ID information.

This application ensures easy search for the position of the ID information, even when some geometrical change is applied to the embedded image.

In the ID card reading method of the present invention, it is preferable that the step (c) applies discrete cosine transform or discrete Fourier transform for the transform.

The discrete cosine transform and the discrete Fourier transform are typical transformed into the frequency domain.

The present invention is not restricted to the ID card, the ID card issuing device, the ID card reading device, the corresponding ID card issuing method, or the corresponding ID card reading method. The technique of the present invention is attained by a diversity of other applications, for example, computer programs for actualizing such devices and methods, recording media in which such computer programs are recorded, and data signals that include such computer programs and are embodied in carrier waves.

These and other objects, features, aspects, and advantages of the present invention will become more apparent from the following detailed description of the preferred embodiment with the accompanying drawings.

### BRIEF DESCRIPTION OF THE DRAWINGS

FIG. 1 is a plan view illustrating an ID card in one embodiment of the present invention;

FIG. 2 is a block diagram schematically illustrating the construction of an ID card issuing device that is capable of issuing the ID card shown in FIG. 1;

FIG. 3 shows an example of photographic image;

FIG. 4 is a flowchart showing a series of digital watermark embedding process executed by the ID card issuing device of FIG. 2;

FIG. 5 shows frequency components generally obtained by DCT (discrete cosine transform);

FIG. 6 shows a bit information location region and the position of a marker attached;

FIG. 7 shows a watermark image including bit information in one example;

FIG. 8 shows a resulting watermark image after attachment of the marker in the example;

FIG. 9 shows a resulting watermark image after adjustment on a brightness axis with a series of random digits in the example;

FIG. 10 shows a resulting watermark image after addition of virtual pixels in the example;

FIG. 11 shows a resulting photographic image after addition of virtual pixels in one example;

FIG. 12 shows a transformed image obtained by IDCT (inverse discrete cosine transform) in the example;

FIG. 13 shows a resulting embedded image in the example;

FIG. 14 shows a final embedded image after deletion of virtual compensating pixels;

FIG. 15 is a block diagram schematically illustrating the construction of the ID card reading device that is capable of reading the ID information from the ID card shown in FIG. 1;

FIG. 16 is a flowchart showing a series of digital watermark extracting process executed by the ID card reading device of FIG. 15;

FIG. 17 shows a resulting embedded image after filtering process in one example;

FIG. 18 shows a transformed image obtained by DCT in the example;

FIG. 19 shows an embedded image with a geometrical change in one example;

FIG. 20 shows a transformed image obtained from the embedded image of FIG. 19 in the example;

FIG. 21 shows an embedded image with a geometrical change in another example;

FIG. 22 shows a transformed image obtained from the embedded image of FIG. 21 in the example;

FIG. 23 shows an embedded image with a geometrical change in still another example;

FIG. 24 shows a transformed image obtained from the embedded image of FIG. 23 in the example;

FIG. 25 shows a comparison of the bit information location region between the embodiment and a comparative example; and

FIG. 26 shows an embedded image without any adjustment on the brightness axis with the series of random digits.

### DESCRIPTION OF THE PREFERRED EMBODIMENTS

One mode of carrying out the present invention is discussed below as a preferred embodiment in the following sequence:

A. ID Card

B. ID Card Issuing Device

C. ID Card Reading Device

D. Effects of Embodiment

E. Modification

A. ID Card

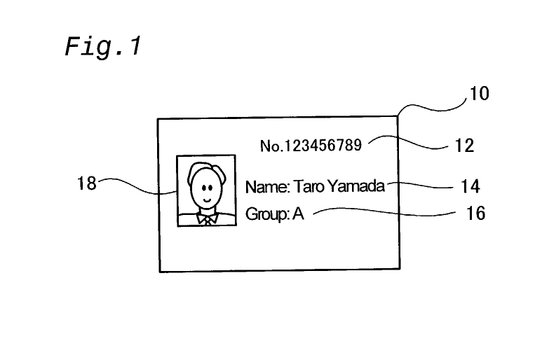

FIG. 1 is a plan view illustrating an ID card 10 in one embodiment of the present invention. As shown in FIG. 1, ID information for identifying a holder of the ID card 10 including ID number 12, name 14, and group 16 of the ID card holder and a head shot of the ID card holder are recorded respectively as character data and a photographic image 18 on the surface of the ID card 10.

One feature of the embodiment is that an identical number with the ID number 12 is embedded as a digital watermark in the photographic image 18 recorded in the ID card 10, although not being specifically illustrated.

B. ID Card Issuing Device

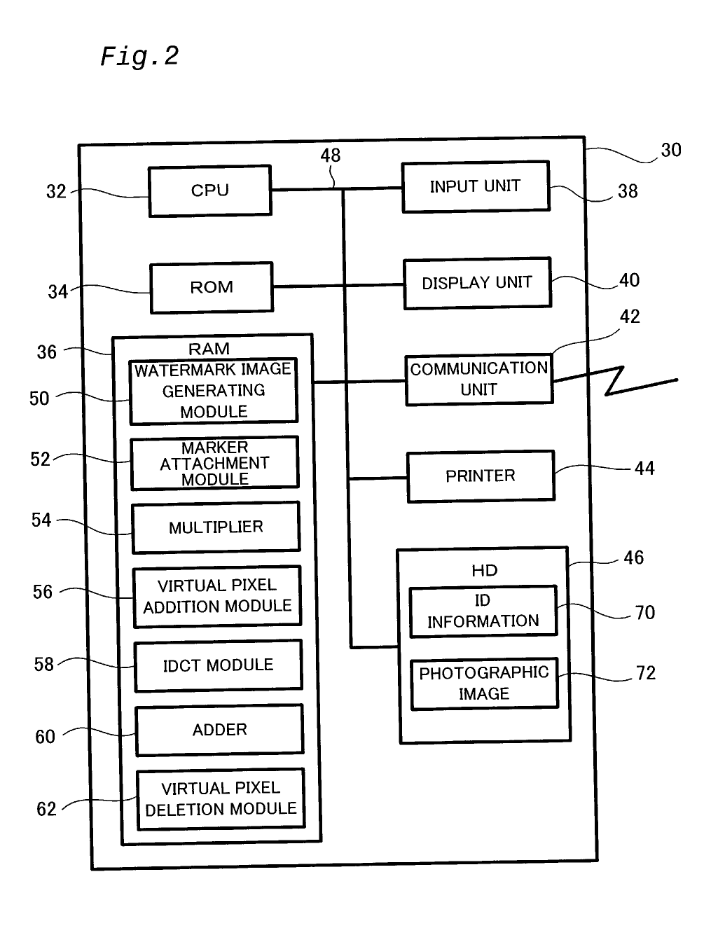

The ID card 10 is issued by an ID card issuing device 30 shown in FIG. 2. FIG. 2 is a block diagram schematically illustrating the construction of the ID card issuing device 30 that is capable of issuing the ID card 10 shown in FIG. 1.

The ID card issuing device 30 shown in FIG. 2 is actualized by a computer including a CPU 32, a ROM 34, a RAM 36, an input unit 38 such as a keyboard and a mouse, a display unit 40 such as a CRT or a liquid crystal display, a communication unit 42 such as a network card, a printer 44 such as a thermal transfer printer, an ink jet printer, or a laser printer, a hard disk unit 46, and a bus 48 connecting these constituents with one another.

Respective interface circuits are omitted from the illustration of FIG. 2. The communication unit 42 is connected to a computer network via a communication line.

The hard disk unit 46 stores therein ID information 70 for identifying each object as a prospective ID card holder and a photographic image 72, typically a head shot, of the object in the form of data. The ID information 70 includes the date of birth, the gender, and the postal address in addition to the ID number, the name, and the group. The data of the photographic image 72 is obtained by photographing the head of each object with a digital camera or by reading a head shot of each object with a scanner.

The RAM 36 stores therein a computer program for attaining the functions of a watermark image generating module 50, a marker attachment module 52, a multiplier 54, a virtual pixel addition module 56, an inverse discrete cosine transform (IDCT) module 58, an adder 60, and a virtual pixel deletion module 62. The CPU 32 executes this computer program to actualize the functions of the respective modules 50 through 62.

This computer program is provided in a specific form recorded in a computer readable recording medium, such as a flexible disk or a CD-ROM. The computer reads the computer program from the recording medium and transmits the input computer program to the RAM 36 directly or via the hard disk unit 46. The computer program may alternatively be supplied from a server or any equivalent on the computer network to the computer via the communication line.

In the specification hereof, the computer is a concept including a hardware and an operating system, and represents the hardware working under control of the operating system. In the case where the operating system is unnecessary and the hardware is driven and actuated by an application program alone or by a firmware alone, the hardware itself corresponds to the computer. The hardware includes at least a CPU and means for reading the computer program recorded in the recording medium. The computer program includes program codes that cause the computer to actualize the functions of the respective modules discussed above. Part of the functions may be actualized by the operating system, instead of the application program.

The ‘recording medium’ may be any of flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

The ID card issuing device 30 having the construction discussed above issues one ID card 10 for each object or prospective ID card holder. The CPU 32 extracts the ID number of the object from the ID information 70 on the object stored in the hard disk unit 46 and converts the extracted ID number into bit information of values 0 and 1. The CPU 32 also reads the data of the photographic image 72 of the object from the hard disk unit 46. The data of the photographic image 72 is color image data of M×N pixels in size, where the color of each pixel is expressed by color components R (red), G (green), and B (blue).

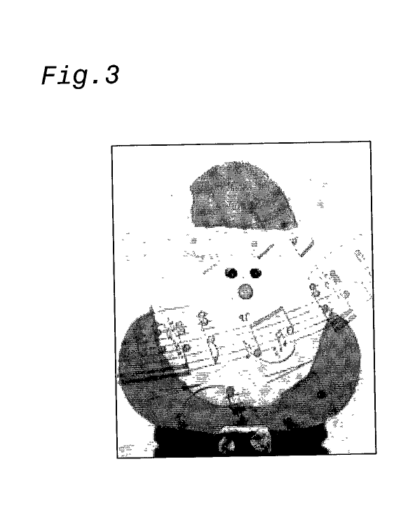

FIG. 3 shows an example of photographic image. For matter of convenience, a photograph of a Santa Claus doll, instead of the photographic image of the object, is used in FIG. 3 and the subsequent drawings.

The CPU 32 embeds the resulting converted bit information as a digital watermark into the read-out data of the photographic image 72.

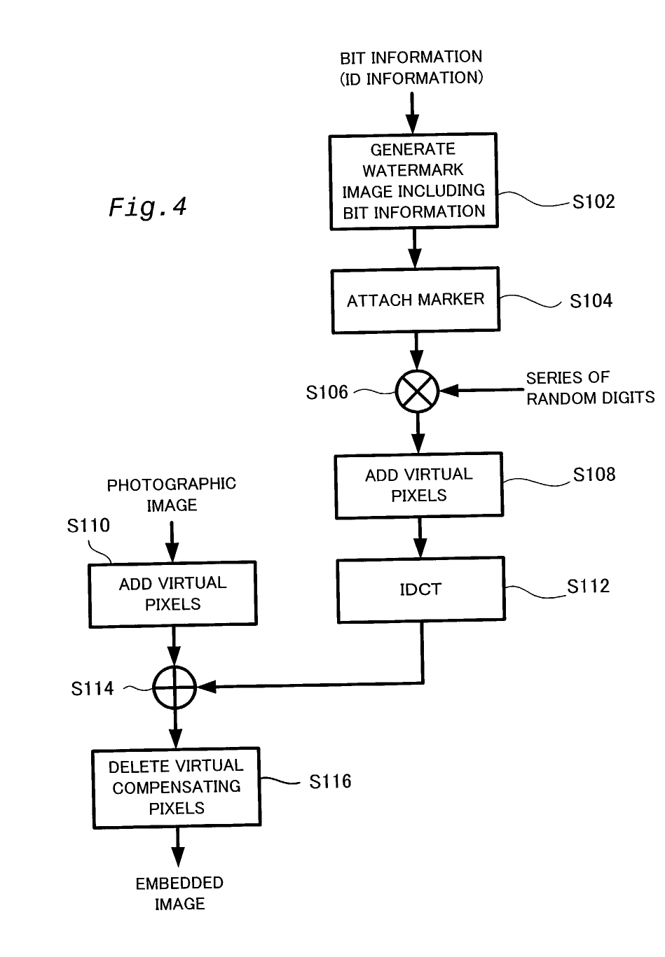

FIG. 4 is a flowchart showing a series of digital watermark embedding process executed by the ID card issuing device 30.

When the program enters the processing routine of FIG. 4, the watermark image generating module 50 shown in FIG. 2 first generates a watermark image including the bit information (step S102). A concrete procedure defines the bit information as a graphic and generates a watermark image including the graphical bit information at a desired position. The watermark image is a binary image of M×N pixels in size that is identical with the size of the photographic image 18, where the color of each pixel is either white or black. The procedure of this embodiment carries out the subsequent steps of the digital watermark embedding routine on the assumption that such a watermark image is an image located in a frequency domain obtained by discrete cosine transform (DCT).

In general, a two-dimensional DCT expressed by Equation (1) given below is applicable for two-dimensional discrete values like image data:

$$\begin{matrix}D ( u , v ) = c ( u ) c ( v ) \frac{2}{\sqrt{M N}} {\sum }_{m = 0}^{M - 1} {\sum }_{n = 0}^{N - 1} G ( m , n ) cos \frac{( 2 m + 1 ) u π}{2 M} cos \frac{( 2 n + 1 ) v π}{2 N} \\ u = 0 , 1 , … , M - 1 v = 0 , 1 , … , N - 1 c ( u ) , c ( v ) = \{ \begin{matrix}1 / \sqrt{2} & u , v = 0 \\ 1 & u , v \neq 0\end{matrix}\end{matrix} \qquad ( 1 )$$

where G(m,n) denotes image data and D(u,v) denotes a DCT coefficient (frequency component).

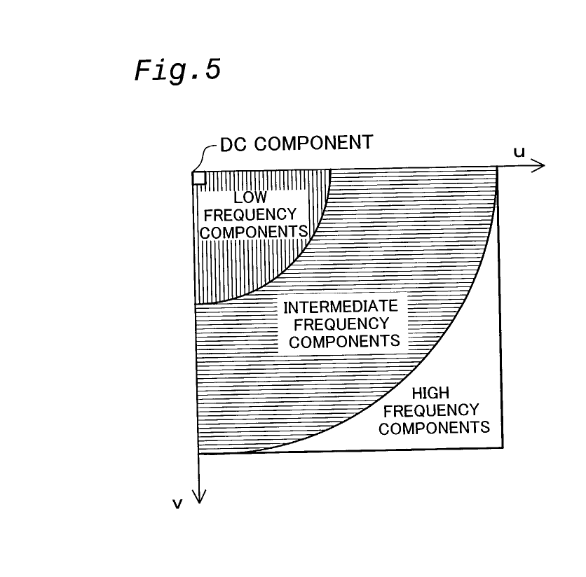

FIG. 5 shows frequency components generally obtained by the DCT. Among the frequency components (DCT coefficients) shown in the graph of FIG. 5, a component located at the upper left point is called a direct current (DC) component and defines the total quantity of energy. The other frequency components are arranged in an order of low frequency components, intermediate frequency components, and high frequency components according to the distance from the DC component. Components of an identical frequency are located on an identical arc about the DC component. Among these frequency components, the low frequency components define the rough contour of the image, and the higher frequency components define the finer details of the image.

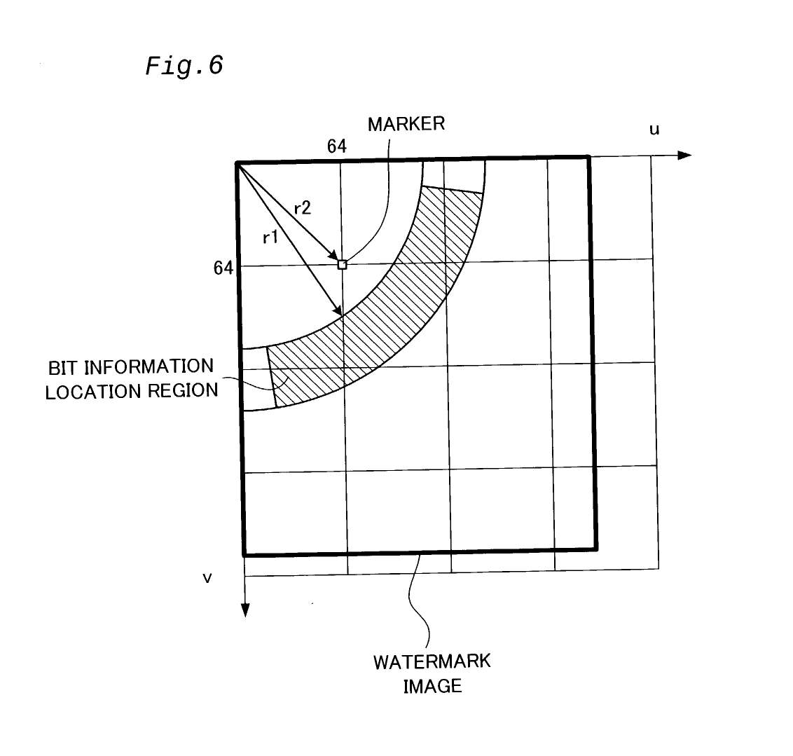

The watermark image generating module 50 defines the bit information as a graphic and locates the graphical bit information in a bit information location region (hatched area) extending along an arc about the upper left point (corresponding to the DC component) as shown in FIG. 6.

FIG. 6 shows the bit information location region and the position of a marker attached as discussed later. As shown in FIG. 6, the bit information location region is an area of either the low frequency components or the intermediate frequency components and is defined by two arcs about the upper left point (corresponding to the DC component).

In the example of FIG. 6, when each square in u-v coordinates has a size of 64×64 pixels, a distance r1 from the upper left point to the bit information location region is equal to 106 pixels.

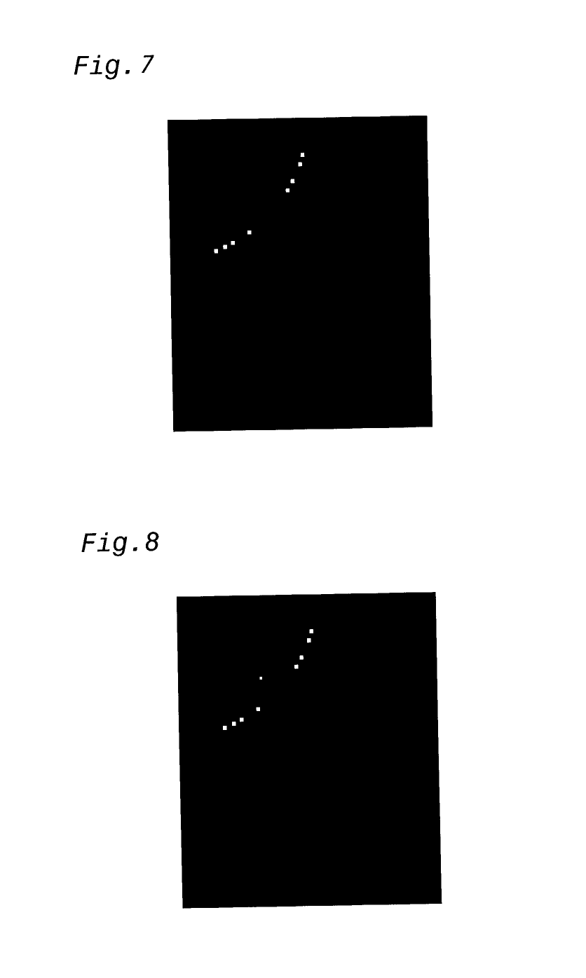

FIG. 7 shows a watermark image including bit information in one example. As shown in FIG. 7, respective pieces of bit information are defined as graphics and are arranged to be located on an identical arc about the upper left point (corresponding to the DC component), where possible, in the bit information location region shown in FIG. 6. Each piece of bit information is, for example, defined as a graphical block of 3×3 pixels in size and a brightness B (where B>0).

The marker attachment module 52 attaches a marker to a predetermined position in the generated watermark image (step S104).

As shown in FIG. 6, when each square in the u-v coordinates has the size of 64×64 pixels, the marker is located at the position of (u,v) =(64,64). A distance r2 from the upper left point to this marker is equal to 90 pixels. Namely a ratio r1/r2 of the distance r1 between the upper left point and the bit information location region to the distance r2 between the upper left point and the marker is equal to 1.18.

FIG. 8 shows a resulting watermark image after attachment of the marker in the example. As shown in FIGS. 6 and 8, the marker has, for example, a size of 2×2 pixels and a brightness k×B (where k≧1) relative to the brightness B of the bit information.

The multiplier 54 successively multiplies the value of each pixel included in the watermark image by a value in a preset series of random digits (step S106), and adjusts the values on the brightness axis with regard to all the pixels in the watermark image. The series of random digits includes M×N random digits equal to either 0 or 1.

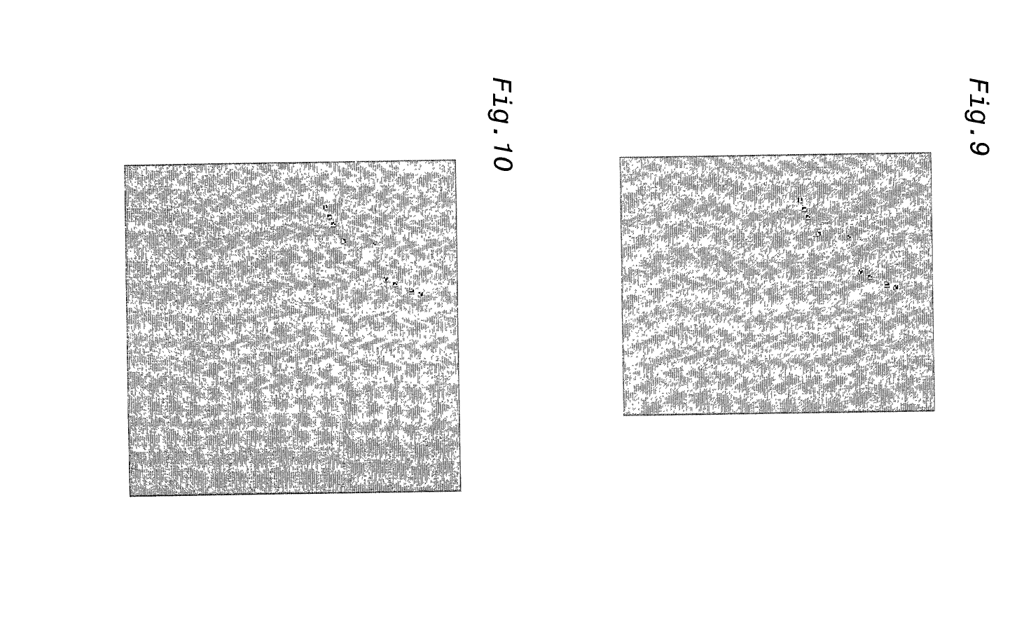

FIG. 9 shows a resulting watermark image after adjustment on the brightness axis with the series of random digits in the example. As shown in FIG. 9, adjustment on the brightness axis with the series of random digits causes white pixels and black pixels to be substantially equally arranged in the whole watermark image. The white pixels and the black pixels are mixed in a certain level in each piece of the bit information and in the marker.

The virtual pixel addition module 56 adds virtual pixels to compensate for an insufficiency and make the size of the watermark image equal to a preset size (step S108).

In one example, it is assumed that the preset size is 2ⁿ×2ⁿ pixels (where n is an integer of not less than 2; M, N≦2ⁿ). The size of the watermark image is M×N pixels, that is, M pixels in the u direction and N pixels in the v direction in the graph of FIG. 6. Namely 2ⁿ-M pixels in the u direction and 2ⁿ-N pixels in the v direction are shorts. The procedure adds virtual pixels to compensate for the insufficiency and generates a new watermark image having the size of 2ⁿ×2ⁿ, that is, L pixels in both the u direction and the v direction.

FIG. 10 shows a resulting watermark image after addition of virtual pixels in the example. As shown in FIG. 10, addition of virtual pixels results in a square watermark image having the size of 2ⁿ×2ⁿ pixels.

The virtual pixel addition module 56 carries out the above series of processing with regard to the photographic image as well as the watermark image. The virtual pixel addition module 56 adds virtual pixels to compensate for an insufficiency and make the size of the photographic image equal to the preset size.

As described above, when the preset size is, for example, 2ⁿ×2ⁿ pixels, the procedure adds virtual pixels, 2ⁿ-M pixels in the u direction and 2ⁿ-N pixels in the v direction, so as to generate a new photographic image of L×L pixels in size.

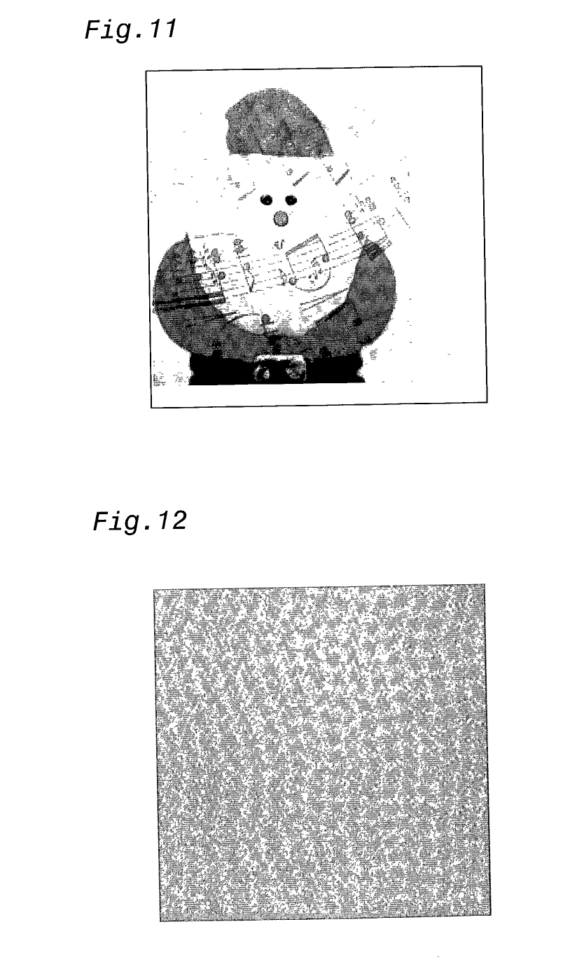

FIG. 11 shows a resulting photographic image after addition of virtual pixels in one example. As shown in FIG. 11, as in the case of the watermark image, addition of virtual pixels results in a square photographic image having the size of 2ⁿ×2ⁿ pixels.

The IDCT module 58 subsequently causes the whole resulting watermark image to be subjected to inverse discrete cosine transform (IDCT) without division of the image into blocks, on the assumption of the watermark image as an image located in a frequency domain obtained by the DCT, thus generating an image in a spatial area (transformed image) (step S112).

FIG. 12 shows a transformed image obtained by the IDCT in the example. As shown in FIG. 12, the IDCT causes the bit information located on an identical arc about the upper left point to be uniformly dispersed over the whole image.

The adder 60 then adds the value of a corresponding pixel in the transformed image to the value of each pixel in the photographic image, and embeds the bit information as a digital watermark in the photographic image, thus generating an embedded image (step S114).

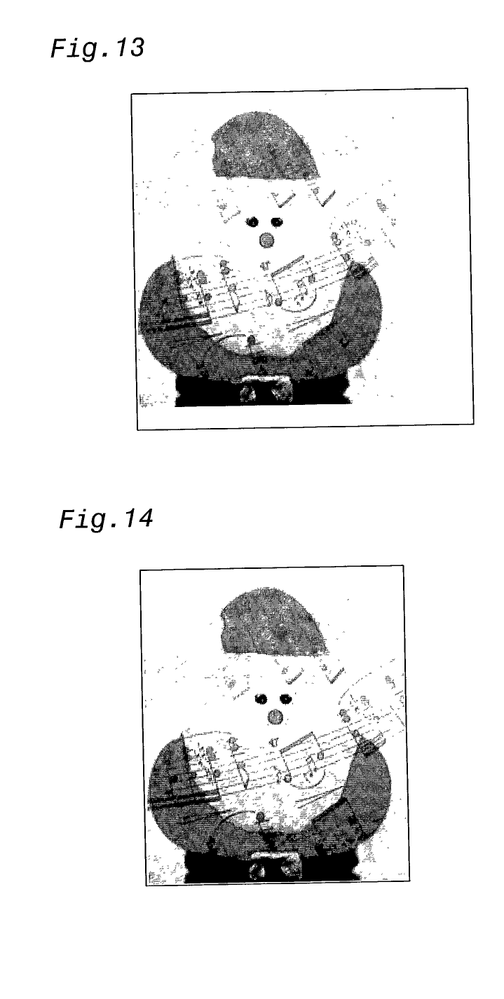

FIG. 13 shows a resulting embedded image in the example. Addition of the transformed image of FIG. 12 to the photographic image of FIG. 11 gives the embedded image of FIG. 13 with the bit information embedded therein as a digital watermark.

The virtual pixel deletion module 62 then deletes the virtual pixels added at steps S108 and S110 (step S116).

Since 2ⁿ-M pixels in the u direction and 2ⁿ-N pixels in the v direction have been added virtually, the procedure deletes these virtual compensating pixels from the resulting embedded image and completes a final embedded image having the identical size with the original size of M×N pixels.

FIG. 14 shows a final embedded image after deletion of virtual compensating pixels. As shown in FIG. 14, deletion of the virtual compensating pixels gives a final embedded image having the identical size with that of the original photographic image shown in FIG. 3.

As described above, the digital watermark embedding routine shown in the flowchart of FIG. 4 is carried out to embed the bit information as a digital watermark into the data of the photographic image 72. When obtaining the data of the resulting embedded image, the CPU 32 reads the ID number, the name, and the group of each object or prospective ID card holder from the ID information 70 of the object stored in the hard disk unit 46 and converts the input pieces of the ID information 70 into character data. The CPU 32 edits the character data and the data of the embedded image to create document data, and causes the photographic image 18 as shown in FIG. 1 and the ID information 70 to be printed on the surface of a predetermined card, based on the document data stored in the hard disk unit 46. The ID card 10 is accordingly issued for each object or prospective ID card holder.

The ID card 10 issued by the above procedure is distributed to each object or ID card holder under management and is utilized by the ID card holder, for example, in the following manner. Each ID card holder is obliged to carry the own ID card 10. For identification of the ID card holder, a management representative requests the ID card holder to show the ID card 10. The management representative checks the identity of the ID card holder based on the ID information (the ID number, the name, and the group) recorded on the surface of the ID card 10 and compares the ID card holder with the recorded photographic image for the purpose of identification.

C. ID Card Reading Device

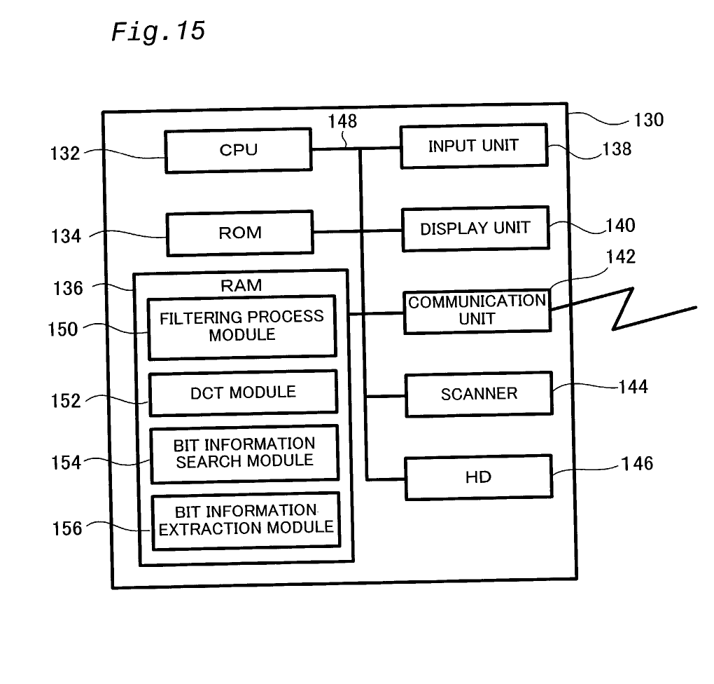

When there is any suspicion of an illegal alteration of the ID card 10, for example, falsification of the photographic image, an ID card reading device 130 shown in FIG. 15 is used to read the bit information (ID information) embedded in the photographic image 18 recorded in the ID card 10 and determine the existence or non-existence of any illegal alteration.

FIG. 15 is a block diagram schematically illustrating the construction of the ID card reading device 130, which is capable of reading the ID information from the ID card 10 of FIG. 1.

Like the ID card issuing device 30 discussed above, the ID card reading device 130 shown in FIG. 15 is actualized by a computer including a scanner 144 for reading the photographic image and the ID information recorded in the ID card, in addition to a CPU 132, a ROM 134, a RAM 136, an input unit 138, a display unit 140, a communication unit 142, a hard disk unit 146, and a bus 148. Respective interface circuits are also omitted from the illustration of FIG. 15. The communication unit 142 is connected to the computer network via a communication line.

The RAM 136 stores therein a computer program for attaining the functions of a filtering process module 150, a discrete cosine transform (DCT) module 152, a bit information search module 154, and a bit information extraction module 156. The CPU 132 executes this computer program to actualize the functions of the respective modules 150 through 156.

The ID card reading device 130 having the construction discussed above reads the ID information recorded on the surface of the ID card 10, while scanning the photographic image to extract the ID information embedded in the photographic image as the digital watermark.

When the ID card 10 is set on the scanner 144, the scanner 144 scans the surface of the ID card 10 to read the recorded data. The CPU 132 receives the data read by the scanner 144 and separately takes out data in a photograph image recorded section (that is, data of the photographic image) and data in an ID information recorded section from the input data.

The data of the photographic image is a color image of M×N pixels in size, where the color of each pixel is expressed by color components R (red), G (green), and B (blue). In the case of no illegal alteration of the ID card 10, for example, no falsification of the photographic image, the photographic image is supposed to include authentic bit information (ID information) as the digital watermark. In a concrete example, an image as shown in FIG. 13 is extracted as the photographic image or the embedded image.

The CPU 132 subsequently extracts the bit information embedded as the digital watermark from the taken-out data of the photographic image (embedded image).

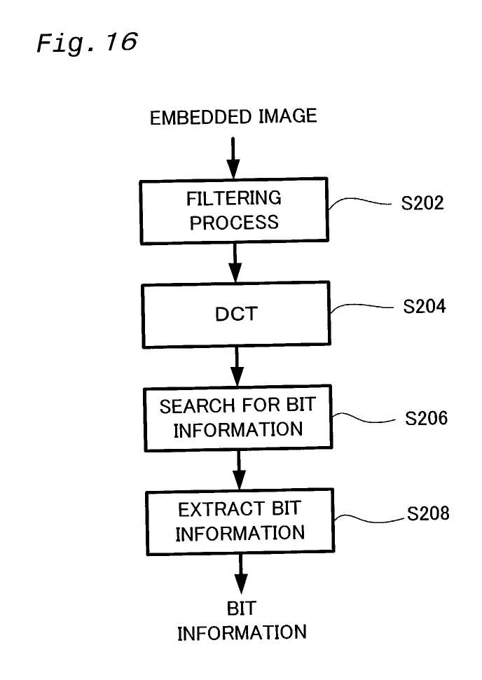

FIG. 16 is a flowchart showing a series of digital watermark extracting process executed by the ID card reading device 130.

When the program enters the processing routine of FIG. 16, the filtering process module 150 first makes the embedded image subjected to a filtering process (step S202). The filtering process eliminates lower frequency components than the frequency of the bit information location region shown in FIG. 6 from the embedded image.

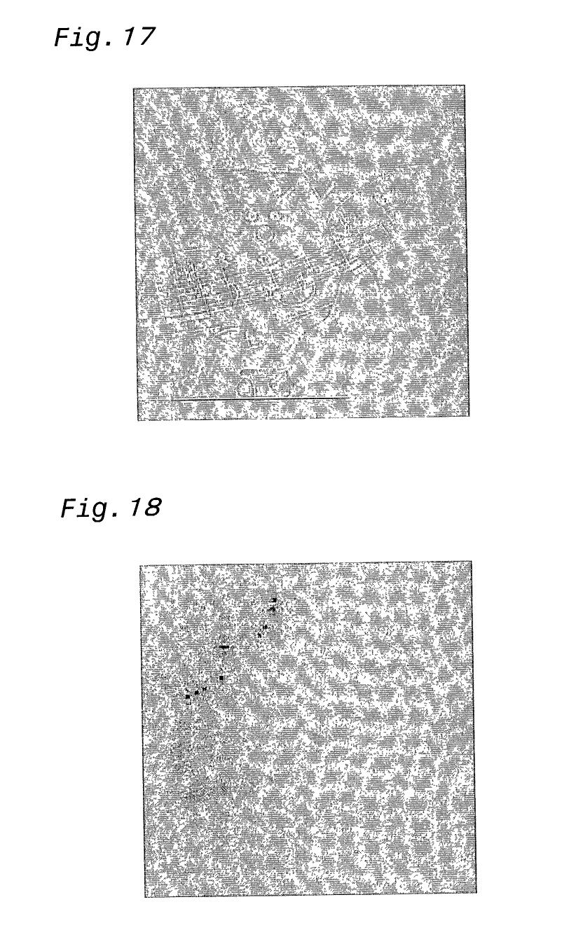

FIG. 17 shows a resulting embedded image after the filtering process in one example. The filtering process gives a resulting image excluding relatively high-leveled frequency components (that is, the DC component and the low frequency components in its neighborhood) as shown in FIG. 17.

The DCT module 152 causes the whole embedded image to be subjected to discrete cosine transform (DCT) without any division of the embedded image into blocks, so as to generate an image in the frequency domain (transformed image) (step S204).

FIG. 18 shows a transformed image obtained by the DCT in the example. As shown in FIG. 18, the DCT of the embedded image gives the transformed image including the embedded bit information.

The bit information search module 154 subsequently detects the marker from the transformed image and specifies a geometrical change of the embedded image based on the status of the detected marker. The bit information search module 154 carries out a correction of the transformed image to compensate for the specified geometrical change, and searches for the position of the bit information (step S206).

As described above, in the structure of this embodiment, the printer 44 prints the resulting embedded image with the bit information embedded therein to issue the ID card 10. The scanner 144 scans the embedded image on the ID card 10 and takes out the data of the embedded image (photographic image). The printing process by means of the printer and the scanning process by means of the scanner give some geometrical change to the data of the final embedded image. Application of the geometrical change to the embedded image shifts the location of the bit information from its original position, thus making it difficult to find the bit information.

The procedure of the embodiment detects the marker attached to the watermark image and specifies the geometrical change applied to the embedded image, as discussed previously.

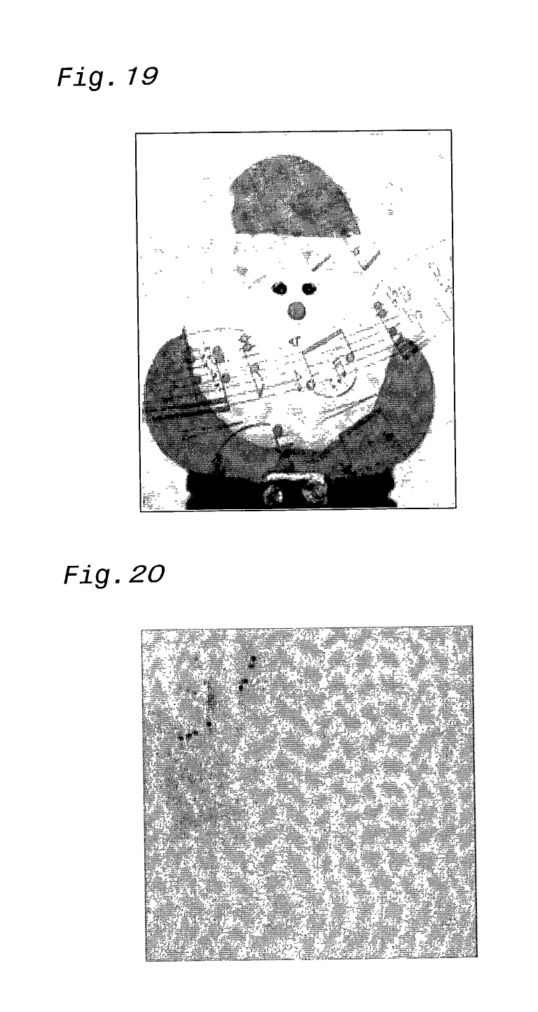

FIGS. 19, 21, and 23 show embedded images with some geometrical changes applied thereto as examples. FIGS. 20, 22, and 24 show transformed images obtained from the embedded images of FIGS. 19, 21, and 23 in the respective examples.

In the example of FIG. 19, the geometrical change is an expansion of the whole image to 120%. In this case, the marker is shifted as shown in FIG. 20.

The marker is shifted to the upper left in the case of an expansion of the image and is shifted to the lower right in the case of a contraction of the image. A rate of expansion α is expressed as α=r2/r2′, where r2 represents an original distance between the upper left point and the original position of the marker and r2′ represents a new distance between the upper left point and the shifted position of the marker. The rate of expansion α is accordingly usable to compensate for the applied geometrical change.

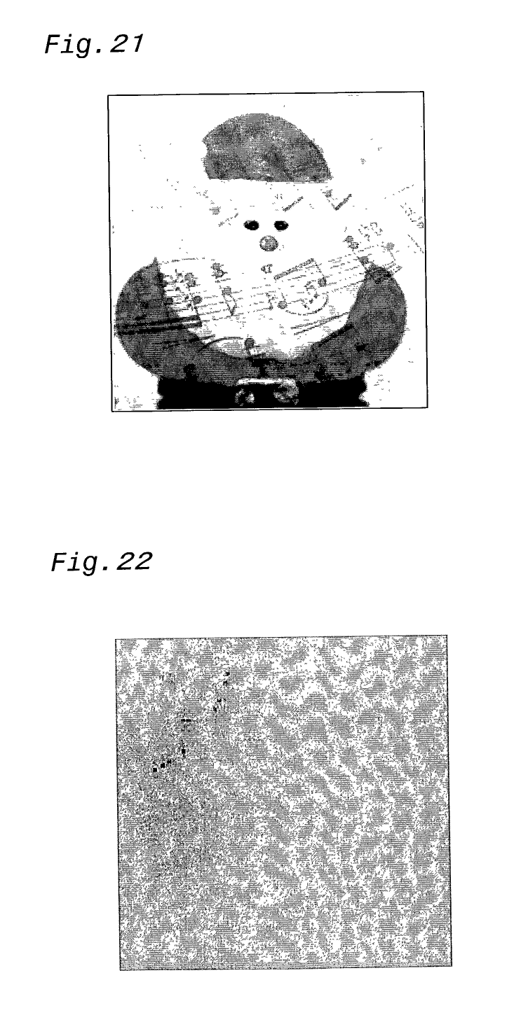

In the example of FIG. 21, the geometrical change is an expansion of the image only in the lateral direction (that is, in the u direction) to 120%, so as to change the aspect ratio. In this case, the marker is shifted as shown in FIG. 22.

The marker is shifted leftward in the case of a change of the aspect ratio of the image, for example, in the case of an expansion of the image only in the lateral direction. A rate of expansion αu in the lateral direction is expressed as αu=r2u/r2u′, where r2u represents an original distance between the v axis and the original position of the marker (that is, the coordinate position of the marker in the u direction) and r2u′ represents a new distance between the v axis and the shifted position of the marker. The rate of expansion au is accordingly usable to compensate for the applied geometrical change.

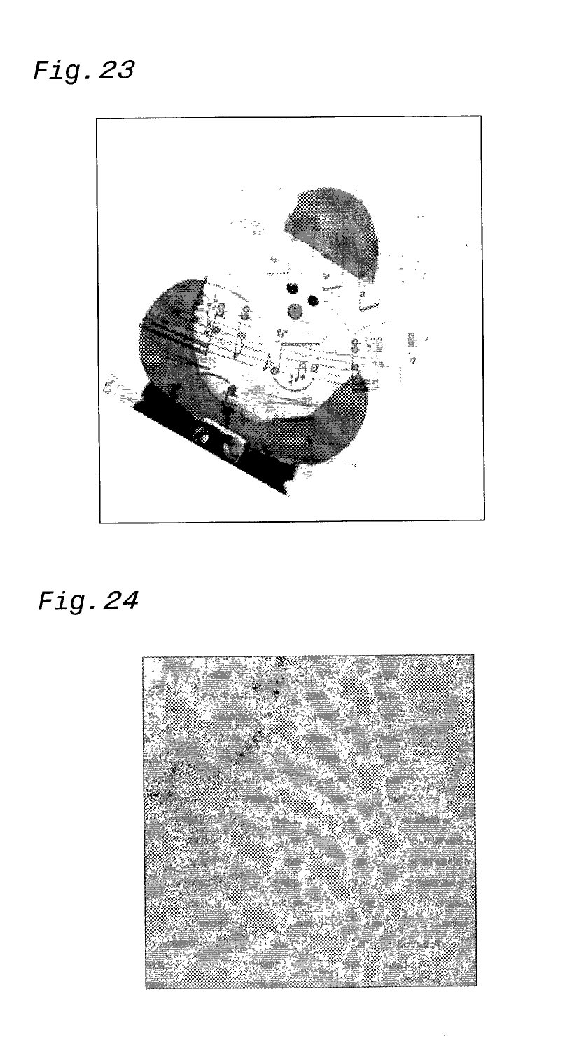

In the example of FIG. 23, the geometrical change is a clockwise rotation of the image by 30 degrees. In this case, two markers appear on concentric circles. A reverse rotation of the image by θ/2 degrees or (90-θ/2) degrees compensates for the applied geometrical change, where θ denotes an angle defined by the upper left point and the two markers. This reveals the accurate position of the bit information.

After search for the position of the bit information, the bit information extraction module 156 extracts the graphical bit information from the transformed image and digitizes the extracted bit information based on a result of the search (step S208).

The bit information is thus extracted from the data of the embedded image according to the digital watermark extracting process shown in FIG. 16. The CPU 132 then reads an ID number from the digitized bit information. The CPU 132 subsequently converts the taken-out data in the ID information recorded section into character data and detects an ID number recorded as one piece of the ID information among the converted character data. The CPU 132 compares the two ID numbers with each other. When the two ID numbers are coincident with each other, it is determined that there is no illegal alteration of the ID card 10, for example, no falsification of the photographic image. In the case of inconsistency, on the other hand, it is determined that there is some illegal alteration of the ID card 10. In the case of no extraction of the bit information from the data of the embedded image by the digital watermark extracting process shown in FIG. 16, the CPU 132 also determines that there is some illegal alteration of the ID card 10, for example, falsification of the photographic image.

As discussed above, the ID card reading device 130 shown in FIG. 15 effectively determines the existence or non-existence of any illegal alteration of the ID card 10.

D. Effects of Embodiment

As described above, even in the case of an illegal alteration of the ID card 10, for example, falsification of the photographic image, the arrangement of the embodiment readily detects the illegal alteration and easily finds out the false identification.

In the structure of the embodiment, the watermark image with the bit information (ID information) embedded therein as the digital watermark is subjected to the IDCT, whereas neither DCT nor IDCT is carried out with regard to the photographic image. Compared with the photographic image, the watermark image is a simpler image having an extremely less quantity of information. A significantly shorter processing time is thus required for the IDCT of the watermark image.

Among the frequency components generally obtained by the DCT, the high frequency components have the lower level than those of the low frequency components and the intermediate frequency components. If the bit information is located in a region of the high frequency components in the process of generating the watermark image at step S102 in the flowchart of FIG. 4, the embedded bit information may cause the deterioration of the picture quality of the final embedded image. The allowable position of the bit information in the region of the high frequency components to prevent such effects on the picture quality is rather limited. Such limitation results in sparse arrangement of the bit information. This makes it difficult to extract the embedded bit information from the embedded image. The arrangement of the embodiment, on the other hand, locates the bit information in a region of the low frequency components or the intermediate frequency components (that is, in the bit information location region shown in FIG. 6), instead of the region of the high frequency components. There is accordingly no possibility of the deteriorating picture quality.

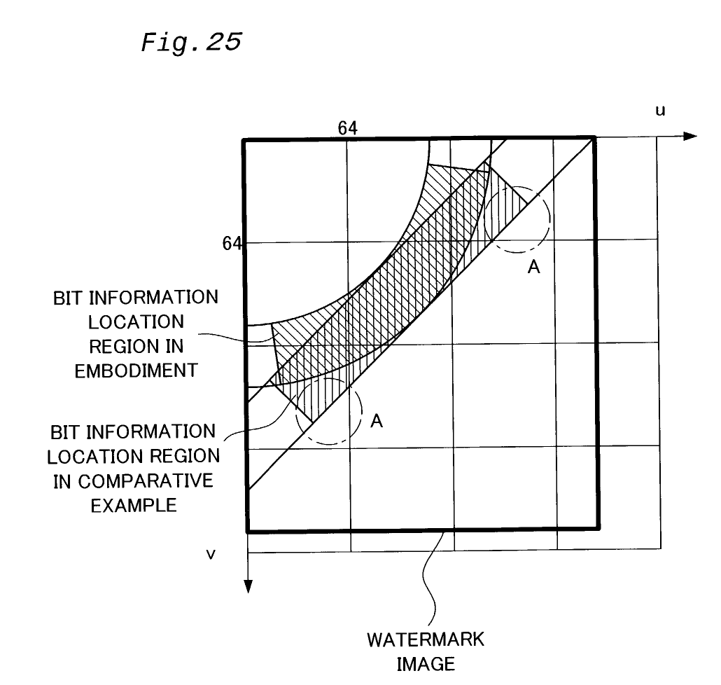

FIG. 25 shows a comparison of the bit information location region between the embodiment and a comparative example. As mentioned previously, in this embodiment, the bit information location region is an area extending along an arc about the upper left point (corresponding to the DC component) as shown in FIG. 25. In the comparative example, the bit information location region is, for example, an area extending along a straight line from the upper right to the lower left. In this comparative example, the respective pieces of bit information are located at positions of different frequencies. Some ranges of the bit information location region encircled by a one-dot chain line A belong to areas of higher frequency components in the comparative example. Arrangement of the bit information in these ranges accordingly causes deterioration of the picture quality. One possible measure for maintaining the picture quality prohibits arrangement of the bit information in these ranges. This measure, however, limits the allowable location of the bit information and thereby undesirably reduces the amount of bit information arranged in the bit information location region of the comparative example. In the bit information location region of the embodiment, on the other hand, the bit information is located in the area of a substantially identical frequency band. The bit information location region of the embodiment accordingly does not have any equivalent area of higher frequency components to the areas encircled by the one-dot chain line A. There is thus little possibility of deterioration of the picture quality. The allowable location of the bit information is not limited, so that a greater amount of bit information can be arranged in the bit information location region.

The technique of the embodiment attaches the marker to the predetermined position in the watermark image at step S104. This arrangement enables the type of the geometrical change applied to the embedded image to be readily specified, thus ensuring easy search for the accurate location of the bit information.

The technique of the embodiment carries out adjustment on the brightness axis with regard to all the pixels included in the watermark image with the series of random digits at step S106. This arrangement effectively prevents the significant change in level of the specific frequency due to the presence of the bit information and the marker, thus effectively reducing the deterioration of the picture quality of the embedded image eventually obtained.

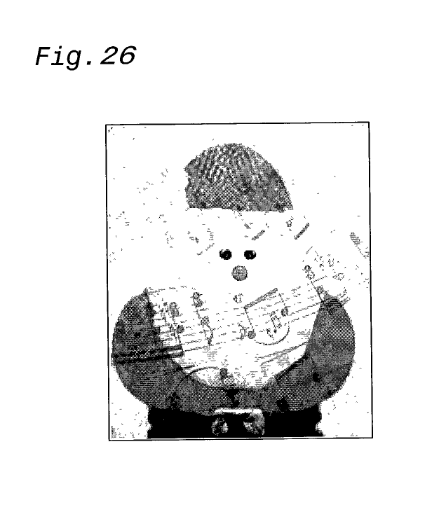

FIG. 26 shows an embedded image without any adjustment on the brightness axis with the series of random digits. The embedded image shown in FIG. 26 is compared with the embedded image subjected to adjustment on the brightness axis with the series of random digits shown in FIG. 14. As clearly understood from the comparison, inexecution of adjustment on the brightness axis with the series of random digits causes some pattern to appear in the whole embedded image as an effect of the embedding, thus deteriorating the picture quality of the resulting embedded image.

The technique of the embodiment applies a transform algorithm, which carries out computation in the unit of 2ⁿ pixels, for the IDCT of the watermark image at step S112. In the case where the size of the watermark image is less than the preset size 2ⁿ×2ⁿ pixels, the technique adds virtual compensating pixels to the watermark image to give a square image of 2ⁿ×2ⁿ pixels in size at step S108. This arrangement facilitates the computation of the IDCT.

As described above, the transform algorithm applied for the computation of the IDCT works in the unit of 2ⁿ pixels. The computation of the IDCT is not significantly complicated when the watermark image is a rectangular image of 2ⁿ×2ⁿ pixels in size (where m and n are integers of not less than 2, and m≠n). The square image of 2ⁿ×2ⁿ pixels in size, however, ensures simpler computation of the IDCT.

As in the case of the watermark image, the technique of the embodiment adds virtual compensating pixels to the photographic image to give the preset size at step S110. This is because that the identical size of the photographic image and the transformed image are preferable in the process of adding the transformed image of the watermark image to the photographic image at step S114.

The procedure of the embodiment makes the whole watermark image subjected to the IDCT without any division of the image into blocks. This arrangement does not require any correction of the position and the shape of the blocks, which is necessary for extraction of the embedded digital watermark by the prior art technique. Even if some geometrical change is applied to the embedded image by the printing process with the printer or by the scanning process with the scanner, the arrangement of the embodiment does not require any sophisticated matching process to correct the positional shift and the deformation of the blocks due to the geometrical change, thus facilitating extraction of the bit information.

Compared with the prior art technique of dividing the watermark image into blocks for the IDCT, this technique of carrying out the IDCT on the whole watermark image without any division of the image into bocks ensures more uniform dispersion of the bit information over the whole image.

The technique of the embodiment deletes the virtual compensating pixels at step S116 and does not make any non-required pixels remain in the final embedded image. The IDCT causes the embedded bit information to be uniformly dispersed over the whole image. Deletion of the virtual pixels accordingly does not lead to elimination of the embedded bit information.

The technique of the embodiment performs the filtering process to exclude the relatively high-leveled frequency components (that is, the DC component and low frequency components in its neighborhood) at step S202, prior to extraction of the bit information from the embedded image. This arrangement ensures easy extraction of the bit information from the embedded image.

E. Modification

The above embodiment and its applications are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

In the above embodiment, the IDCT module 58 carries out the IDCT of the watermark image at step S112, and the DCT module 152 carries out the DCT of the embedded image at step S204. The technique of the present invention is, however, not restricted to this arrangement. For example, an inverse discrete Fourier transform (IDFT) module, instead of the IDCT module, may be provided to carry out IDFT of the watermark image. A discrete Fourier transform (DFT) module, instead of the DCT module, may also be provided to carry out DFT of the embedded image.

In the above embodiment, the head shot of the ID card holder is used as the photographic image recorded in the ID card. The full-length photograph, the fingerprint photograph, or the iris photograph of the ID card holder may be used instead.

In the above embodiment, the ID number is selected as the piece of information embedded in the photographic image as the digital watermark. The name or the group may alternatively be selected as the piece of information to be embedded. Some biometric information like the fingerprint or the iris of the ID card holder or a hash value based on partial data of the photographic image (for example, the head shot) may also be used as the ID information recorded on the surface of the ID card or as the ID information embedded in the photographic image as the digital watermark.

The procedure of the embodiment converts the ID information into the bit information and defines the bit information as a graphical block to generate the watermark image including the ID information. One possible modification may define the ID information as a graphic in the form of characters. Another possible modification may define the ID information as a graphic in the form of a logo.

In the above embodiment, the ID information is recorded on the surface of the ID card by printing. Part or all of the ID information may be recorded in the ID card by magnetic or optical means, instead of or in combination with the printing. The ID card may have an IC, in which the ID information is recorded.

In the above embodiment, the ID card issuing device 30 shown in FIG. 2 stores the photographic image and the ID information, which are to be recorded in the ID card, in the hard disk unit 46 and uses the contents of the hard disk unit 46 to issue the ID card. The technique of the present invention is, however, not restricted to this arrangement. In one possible modification, part or all of the photographic image and the ID information are stored in a server on the computer network. The ID card issuing device 30 actuates its internal communication unit 42 to access the server and fetch the required data and records the fetched photographic image and ID information into the ID card.

The procedure of the embodiment compares the ID information (that is, the ID number) embedded as the digital watermark in the photographic image of the ID card with the ID information recorded on the surface of the ID card to determine the existence or non-existence of any illegal alteration of the ID card. The technique of the present invention is, however, not restricted to this arrangement. In one possible modification, the ID information is stored in the form of a database in the hard disk unit 146 of the ID card reading device 130 shown in FIG. 15. The modified procedure retrieves the hard disk unit 146 to find the ID information corresponding to the ID information embedded in the photographic image of the ID card (for example, the ID number), makes the corresponding ID information displayed on the display unit 140, and causes the management representative to identify the ID card holder based on the displayed information. In another possible modification, the photographic image linked with the ID information is stored in the hard disk unit 146. The modified procedure reads the photographic image linked with the ID information from the hard disk unit 146 based on the ID information (for example, the ID number) embedded in the photographic image of the ID card, makes the photographic imaged displayed on the displayed unit 140, and compares the displayed photographic image with the photographic image on the ID card and the ID card holder for identification. In still another possible modification, the ID information and the photographic image are stored in a server on the computer network. The ID card reading device 130 actuates the internal communication unit 142 to access the server, reads the ID information and the photographic image from the server based on the ID information (for example, the ID number) embedded in the photographic image, and carries out the identification as discussed above.

In such applications of reading the ID information and the photographic image from the ID card reading device 130 or from the server on the computer network based on the ID information embedded in the photographic image of the ID card, it is sufficient that at least the photographic image with the ID information (for example, the ID number) embedded therein is recorded in the ID card. The other information may not be recorded in the ID card. Namely only the photographic image with the ID information embedded therein may be recorded in the ID card.

As described above, the procedure of the embodiment applies the transform algorithm, which carries out computation in the unit of 2ⁿ pixels, for the IDCT of the watermark image. Another transform algorithm, which does not carry out the computation in the unit of 2ⁿ pixels, is also applicable. In the latter case, neither the virtual pixel addition process of steps S108 and S110 nor the virtual pixel deletion process of step S116 is required.

In the case of the transform algorithm that carries out computation in the unit of 2ⁿ pixels at step S112, when the process of step S102 originally generates a square watermark image of 2ⁿ×2ⁿ pixels in size, the virtual pixel addition process of step S108 is not required.

The virtual compensating pixels may be deleted from the transformed image, after the IDCT of the watermark image is carried out at step S112. In this case, the photographic image and the transformed image have an identical size when the transformed image of the watermark image is added to the photographic image at step S114. Neither the virtual pixel addition process of step S110 nor the virtual pixel deletion process of step S116 is accordingly required for the photographic image.

In the above embodiment, the filtering process eliminates the lower frequency components than the frequency of the bit information location region from the embedded image. One modified procedure may eliminate higher frequency components than the frequency of the bit information location region, as well as the lower frequency components than the frequency of the bit information location region.

The above embodiment applies the DCT or the DFT for the inverse transform from the frequency domain or the transform to the frequency domain. Any of other diverse orthogonal transformations, such as wavelet transform or modified discrete cosine transform (MDCT) may be adopted instead.

The above embodiment adds (or subtracts) the watermark image to (or from) the photographic image to obtain the embedded image. The embedded image may otherwise be obtained by any of other diverse operations, such as multiplication or division.

The scope and spirit of the present invention are indicated by the appended claims, rather than by the foregoing description.

What is claimed is:

1. An ID card with an embedded image recorded therein by means of printing, wherein the embedded image has first ID information for identifying a person embedded therein as a digital watermark, the embedded image being obtained by assuming a watermark image including the first ID information as an image located in a certain frequency domain, making the whole watermark image subjected to an inverse transform from the frequency domain to generate a transformed image, and adding the transformed image to a photographic image that represents part or whole of the person.

2. An ID card in accordance with claim 1, wherein second ID information for identifying the person is further recorded in said ID card.

3. An ID card issuing device that issues an ID card, said ID card issuing device comprising:
an inverse transform module that assumes a watermark image including ID information for identifying a person as an image located in a certain frequency domain, and makes the whole watermark image subjected to an inverse transform from the frequency domain, so as to generate a transformed image;
an adder that adds the transformed image to a photographic image representing part or whole of the person, so as to obtain an embedded image with the ID information embedded therein as a digital watermark; and
a recording module that records the embedded image in a predetermined card by means of printing, so as to issue said ID card.

4. An ID card reading device that reads information recorded in the ID card, said ID card reading device comprising:
a reading module that reads an embedded image, which is recorded in said ID card and includes a photographic image representing part or whole of a person and ID information for identifying the person embedded in the photographic image as a digital watermark;
a transform module that makes the whole embedded image subjected to a transform into a frequency domain, so as to generate a transformed image; and
an extraction module that extracts the ID information from the transformed image.

5. A method of issuing an ID card, said ID card issuing method comprising the steps of:
(a) providing ID information for specifying a person and a photographic image that represents part or whole of the person;
(b) defining the ID information as a graphic and arranging the graphical ID information at a desired position to generate a watermark image;
(c) assuming the watermark image as an image located in a frequency domain and making the whole watermark image subjected to an inverse transform from the frequency domain, so as to generate a transformed image;
(d) adding the transformed image to the photographic image, so as to obtain an embedded image with the ID information embedded therein as a digital watermark; and
(e) recording the embedded image in a predetermined card by means of printing, so as to issue said ID card.

6. An ID card issuing method in accordance with claim 5, wherein said step (b) arranges the graphical ID information in a specific area of low and intermediate frequency components, which is defined by two arcs about a point corresponding to a direct current component, on the assumption that the watermark image is the image located in the frequency domain.

7. An ID card issuing method in accordance with claim 5, wherein said step (b) comprises the sub-step of attaching a marker to a preset position in the generated watermark image.

8. An ID card issuing method in accordance with claim 5, wherein said step (b) comprises the sub-step of successively multiplying a value of each pixel included in the watermark image by a value extracted from a series of random digits prepared in advance to carry out adjustment of the watermark image on its brightness axis.

9. An ID card issuing method in accordance with claim 5, wherein said step (b) comprises the sub-step of adding virtual compensating pixels to make a size of the generated watermark image equal to a preset size.

10. An ID card issuing method in accordance with claim 5, wherein said step (c) applies inverse discrete cosine transform or inverse discrete Fourier transform for the inverse transform.

11. A method of reading information recorded in an ID card, said ID card reading method comprising the steps of:
(a) providing said ID card with an embedded image recorded therein, where the embedded image has ID information for identifying a person embedded as a digital watermark in a photographic image representing part or whole of the person;
(b) reading the embedded image from said ID card;
(c) making the whole embedded image subjected to a transform into a frequency domain, so as to generate a transformed image; and
(d) extracting the ID information from the transformed image.

12. An ID card reading method in accordance with claim 11, wherein said step (b) comprises the sub-step of making the embedded image subjected to a filtering process.

13. An ID card reading method in accordance with claim 11, wherein said step (d) comprises the sub-step of detecting a marker in the transformed image, specifying a geometrical change applied to the embedded image based on a status of the detected marker, carrying out a correction to compensate for the geometrical change, and searching for a position of the ID information.

14. An ID card reading method in accordance with claim 11, wherein said step (c) applies discrete cosine transform or discrete Fourier transform for the transform.

15. A computer readable recording medium in which a computer program for issuing an ID card is recorded, said computer program causing a computer to attain the functions of:
defining ID information for identifying a person as a graphic and arranging the graphical ID information at a desired position to generate a watermark image;
assuming the watermark image as an image located in a frequency domain and making the whole watermark image subjected to an inverse transform from the frequency domain, so as to generate a transformed image; and
adding the transformed image to a photographic image, which represents part or whole of the person, so as to obtain an embedded image, which is to be recorded in said ID card.

16. A computer readable recording medium in which a computer program for reading information recorded in an ID card is recorded, said computer program causing a computer to attain the functions of:
making a whole embedded image, which has ID information for identifying a person embedded therein as a digital watermark and is read from said ID card, subjected to a transform into a frequency domain, so as to generate a transformed image; and
extracting the ID information from the transformed image.
